(19) United States
(12) Patent Application Publication
(10) Pub. No.: US 2009/0155412 A1
(43) Pub. Date: Jun. 18, 2009

(54) Enzymatic Interesterification Using Stepwise Changes In Temperature For Development of Trans Fat-Free Fats and Oils

(75) Inventors: In Hwan KIM, Seoul (KR); Sun Mi Lee, Seoul (KR); Bo Mi Lee, Seoul (KR); Ji Eun Oh, Seoul (KR); Myung Chul Kim, Seoul (KR); Hye Kyung Park, Seoul (KR); Jong Wook Kim, Seoul (KR); Kwang II Kwon, Seongju-gun (KR); Jee Young Kim, Seoul (KR); Jee Sun Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Republic of Korea (Management: Korea Food & Drug Administration), Seoul (KR)

(21) Appl. No.: 12/332,472

(22) Filed: Dec. 11, 2008

(30) Foreign Application Priority Data
Dec. 18, 2007 (KR) 10-2007-0132998

(51) Int. Cl. A23D 7/02; A23D 7/00

(52) U.S. Cl. 426/33; 426/601

(57) ABSTRACT

Disclosed herein is a method of preparing trans fat-free oils and fats by an enzymatic interesterification (EI), and trans fat-free oils and fats prepared by the method. Specifically, the method comprises the steps of: 1) mixing fully hydrogenated fat derived from vegetable oil with RBD olive oil; 2) adding lipase to the mixed oil and reacting the mixed oil with lipase at 65 to 80° C. for 1 to 4 hours (1^{st} reaction step); and 3) reacting the mixed oil from step 2) with the lipase at 40 to 60° C. for 44 to 47 hours (2^{nd} reaction step).

### FIELD OF THE INVENTION

The present invention relates to trans fat-free oils and fats and a method of preparing the oils and fats. Specifically, the present invention relates to a method of preparing trans fat-free oils and fats comprising the steps of 1) mixing fully hydrogenated fat derived from vegetable oil with RBD olive oil; 2) adding lipase to the mixed oil and reacting the mixed oil with lipase at 65 to 80° C. for 1 to 4 hours (1^{st} reaction step); and 3) reacting the mixed oil from step 2) with the lipase at 40 to 60° C. for 44 to 47 hours (2^{nd} reaction step). The present invention further relates to trans fat-free oils and fats prepared by the method.

### BACKGROUND OF THE INVENTION

It is known that most trans fats are produced in a large amount during the process of hydrogenation of vegetable oil and the fats are largely contained in partially hydrogenated fats among others. These partially hydrogenated fats are used in processed fats such as margarine, shortening, etc. and the products using the processed fats as a main material such as snacks, cookies, bread, chocolate, etc. According to the change of modern day food consumption patterns, the processed product or fast food in diet increases in amount and, consequently, uptake of trans fat is increasing. In this regard, it has been reported that trans fat causes various diseases such as arteriosclerosis, heart disease, etc. To solve this problem, efforts to develop a method that provides trans fat-free oils and fats have been made. As an example, conventional oil mixed with solvent or the oil alone was crystallized using stepwise changes in temperature, thereby obtaining several fractions. The obtained fractions have different physical properties. This method utilizing the physical property of oil has an advantage to provide natural oil, but this method has a problem that the product has a low solid fat index, thus limiting the use of the product as a material for the preparation of margarine and shortening.

Methods exist to improve oil hydrogenation by changing a reaction condition, a catalyst, etc. such as an electro-catalytic hydrogenation, a precise catalytic hydrogenation, a supercritical fluid state catalytic hydrogenation and the like. However, since these methods are also based on a traditional process for hydrogenation, underlying solutions are still needed. Meanwhile, fully hydrogenated fat provided by complete hydrogenation is almost free from trans fat, and thus has been used in reducing trans fat.

Interesterification reaction is a major method for the preparation of hydrogenated fat and includes a chemical interesterification (CI) process and an enzymatic interesterification process (EI). In the case of CI, alkaline catalyst is usually used and sodium methoxide is the most widely used catalyst. The CI method is currently used by major oil processing companies to produce many kinds of processed oil and fat products. In the case of EI, lipase is used as a catalyst. It is known that the activity and specificity of lipase varies depending on the kinds of microorganisms that produce it. The merit of EI resides in that the process by EI method is relatively simple, the production of manufactured goods is easy, trans fat in the goods is almost absent, food safety is guaranteed, and the method is environment-friendly. Thus, there is a worldwide trend to use the enzymatic interesterification process. However, limited knowledge about the conditions for an efficient enzymatic interesterification process is available. Only the reaction conditions at a high temperature have been published.

The present inventors have completed the present invention in an effort to develop trans fat-free oil and fat that can replace partially hydrogenated oil containing a large amount of trans fat, and have found that trans fat-free oil and fat can be prepared, while increasing the residual activity of enzyme by an enzymatic interesterification process comprising mixing fully hydrogenated fat derived from vegetable oil with olive oil, reacting the mixed oil with lipase at a melting temperature of the fully hydrogenated fat, and subsequently reacting the mixed oil with the lipase at a temperature lower than the melting temperature.

### SUMMARY OF THE INVENTION

Accordingly, an object of the present invention is to provide a method that increases the residual activity of lipase by an enzymatic interesterification of the trans fat-free oil using stepwise changes in temperature.

To accomplish said object, the present invention provides a method of preparing trans fat-free oils and fats by an enzymatic interesterification reaction comprising the steps of 1) mixing fully hydrogenated fat derived from vegetable oil with RBD olive oil; 2) adding lipase to the mixed oil and reacting the mixed oil with lipase at 65 to 80° C. for 1 to 4 hours (1^{st} reaction step); and 3) reacting the mixed oil from step 2) with the lipase at 40 to 60° C. for 44 to 47 hours (2^{nd} reaction step). The present invention further provides trans fat-free oils and fats prepared by the method.

Therefore, the present invention has the following advantages. Enzymatic interesterification is conventionally performed at a high temperature. In contrast, since the present method is performed using stepwise changes in temperature, the residual activity of enzyme is increased, which enables the enzyme to be used for a long time. Thus, the present method is beneficial for economy and the reduction of energy consumption. Further, hydrolysis reaction is decreased and, thus, the production of side products such as free fatty acids, monoglycerides, diglycerides, etc. is reduced, thereby lowering refining loss. Further, since the oil and fat that is sensitive to high temperature remains using stepwise changes in temperature, the production of free radical, which is a cause of oil rancidity, is reduced and the quality of the produced oil and fat is improved.

### BRIEF DESCRIPTION OF THE DRAWING

The above and other objects, features and advantages of the present invention will be apparent from the following detailed description of the exemplary embodiment of the invention in conjunction with the accompanying drawing, in which:

FIG. 1 is a graph showing a solid fat content (SFC) of the fats prepared according to Example 1 and Comparative Example 1.

### DETAILED EXPLANATION OF THE INVENTION

The present invention provides a method of preparing trans fat-free oils and fats comprising the steps:

1) mixing fully hydrogenated fat derived from vegetable oil with RBD olive oil;

2) adding lipase to the mixed oil and reacting the mixed oil with lipase at 65 to 80° C. for 1 to 4 hours (1^{st} reaction step); and

3) reacting the mixed oil from step 2) with the lipase at 40 to 60° C. for 44 to 47 hours (2^{nd} reaction step).

As used herein, the term “fully hydrogenated fat” refers to an oil that is prepared by a hydrogenation reaction of vegetable oil wherein the content of fatty acids having a double bond is below 0.2%.

In the present invention, the fully hydrogenated fat derived from vegetable oil includes, but is not limited to, the fully hydrogenated fat derived from canola oil. It is understood that any kinds of fully hydrogenated fats derived from vegetable oil can be used for the enzymatic interesterification reaction using stepwise changes in temperature, so long as they can exert an efficacy that is equivalent to that of the fully hydrogenated fat derived from canola oil. The mixing ratio of fully hydrogenated fat derived from vegetable oil to olive oil is preferably 1:9 to 9:1 by weight ratio, more preferably 4:6 by weight ratio.

The lipase used in the present invention can be derived from microorganisms, plants and animals. The lipase includes, for example, lipases having a specificity to positions 1 and 3 of glyceride that are derived from the microorganisms of Rhizopus delemar, Mucor miehei, Alicaligenes sp., etc.; lipases, random-style, derived from the microorganisms of Aspergillus niger, Candida antarctica, Candida cylindracea, and Geotrichum candidum, etc.; lipases derived from plants of soybean Minuka hima seed; and pancreatic lipases derived from animals. Conveniently, commercially available lipase products can be used. Further, the lipases that are immobilized by adsorption, ionic bonding, covalent bonding, entrapping, etc., such as Lipozyme RM IM (Rhizomucor miehei), Lipozyme TL IM (Thermomyces lanuginosus), and Novozyme 435 (Candida antarctica) from Novo company; Lipase PS-C (Burkholderia cepacia); and Lipase PS-D (Burkholderia cepacia) from Amano company can be used. Further, microorganisms such as fungus, yeast, bacteria, etc. that can produce lipases can be utilized per se.

The melting point of the fully hydrogenated fat used in the present invention is 70° C. In the 1st reaction step at 65˜80° C. for 1 to 4 hours, the melting point of the fat rapidly decreases through the enzymatic interesterification reaction and therefore the 2nd reaction step can be employed at 40˜60° C., which is lower than the temperature in the 1st reaction step, and the residual activity of lipase during the reaction can be maximized.

### PREFERRED EMBODIMENTS OF THE INVENTION

Hereinafter, the present invention is described in further detail with reference to the following examples, but the scope of the present invention is not limited to these examples.

### COMPARATIVE EXAMPLE 1

Fully hydrogenated fat derived from canola oil was mixed with olive oil in a ratio of the fully hydrogenated fat to olive oil of 4:6 by weight, 10 g of the mixed oil was poured into a 50 mL Erlenmeyer flask, and 0.1 g of enzyme lipase was added thereto. After putting a stopper on the flask, the flask was incubated in an orbital shaking water bath (New Brunswick, Model Innova 3100, NJ, USA) with a rotation of 300 rpm at 70° C. for 48 hours.

### EXAMPLE 1

Fully hydrogenated fat derived from canola oil was mixed with olive oil in a ratio of the fully hydrogenated fat to olive oil of 4:6 by weight, 10 g of the mixed oil was poured into a 50 mL Erlenmeyer flask, and 0.1 g of enzyme lipase was added thereto. After putting a stopper on the flask, the flask was incubated in an orbital shaking water bath (New Brunswick, Model Innova 3100, NJ, USA) with a rotation of 300 rpm at 70° C. for 1 hour followed by at 60° C. for 47 hours.

### EXAMPLE 2

Fully hydrogenated fat derived from canola oil was mixed with olive oil in a ratio of the fully hydrogenated fat to olive oil of 4:6 by weight, 10 g of the mixed oil was poured into a 50 mL Erlenmeyer flask, and 0.1 g of enzyme lipase was added thereto. After putting a stopper on the flask, the flask was incubated in an orbital shaking water bath (New Brunswick, Model Innova 3100, NJ, USA) with a rotation of 300 rpm at 70° C. for 2 hours followed by at 60° C. for 46 hours.

### EXAMPLE 3

Fully hydrogenated fat derived from canola oil was mixed with olive oil in a ratio of the fully hydrogenated fat to olive oil of 4:6 by weight, 10 g of the mixed oil was poured into a 50 mL Erlenmeyer flask, and 0.1 g of enzyme lipase was added thereto. After putting a stopper on the flask, the flask was incubated in an orbital shaking water bath (New Brunswick, Model Innova 3100, NJ, USA) with a rotation of 300 rpm at 70° C. for 4 hours followed by at 60° C. for 44 hours.

### TEST EXAMPLE 1

### Analysis of the Degree of Interesterification

To investigate the degree of conversion carried out in Examples 1 to 3 and Comparative Example 1, the content of tristearin was measured by gas chromatography and the ratio of conversion (DC %) was calculated according to Equation 1:

Degree of conversion (DC %)={[initial amount of tristearin (g/100 g)−final amount of tristearin (g/100 g)]/initial amount of tristearin (g/100 g)}×100 Equation 1

TABLE 1
Degree of conversion (DC %)

| Time | Comparative | | | |
|---|---|---|---|---|
| (hours) | Example 1 | Example 1 | Example 2 | Example 3 |
| 0 | 0 | 0 | 0 | 0 |
| 1 | 23 | 23 | 23 | 23 |
| 2 | 35 | 29 | 35 | 35 |
| 4 | 47 | 29 | 41 | 47 |
| 6 | 58 | 38 | 58 | 59 |
| 8 | 62 | 54 | 56 | 64 |
| 12 | 71 | 57 | 58 | 71 |
| 24 | 85 | 75 | 71 | 83 |
| 48 | 85 | 82 | 80 | 82 |

As shown in Table 1, Example 3 showed a degree of conversion similar to that of Comparative Example 1. From this result, it can be seen that Example 3 is an the most effective temperature system of Examples 1 to 3 for an enzymatic interesterification reaction using stepwise changes in temperature.

### TEST EXAMPLE 2

### Comparison of Solid Fat Content

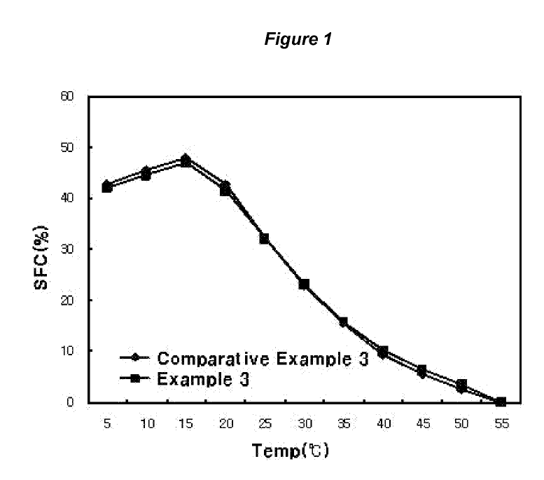

The solid fat content (SFC) of the products prepared from Comparative Example 1 and Example 3 was investigated. A sample of 3 to 5 g was added to a cell for SFC measuring. While increasing temperature stepwise at intervals of 5° C. from 5° C. to 60° C. (12 steps), the solid fat contents in each step were measured. For the measurement, a solid fat content analyzer from Bruker company (Low Resolution NMR) was used. As shown in Table 1, the interesterification reaction in both Comparative Example 1 and Example 3 have reached an equilibrium at the reaction time of 24 hours. Based on this result, SFC was measured for the interesterification reaction equilibrated at 24 hours. The result is shown in FIG. 1. As shown in FIG. 1, there was no significant difference in SFC between Comparative Example 1 and Example 3. Further, the physical properties of the interesterificated fats obtained in Comparative Example 1 and Example 3 were the same.

### TEST EXAMPLE 3

### Residual Activity of Enzyme

From the results of Test Examples 1 and 2, it was shown that the condition in Example 3 is optimum for an enzymatic interesterification using stepwise changes in temperature. The present example provides a comparison of the residual activity of enzyme between Comparative Example 1, which uses a condition of interesterification of high temperature, and Example 3, which uses a condition of interesterification using stepwise changes in temperature. As the equilibrium of the interesterification reaction in Comparative Example 1 and Example 3 was reached 24 hours after the reaction was initiated, the reaction time was set at for 24 hours. In the control group, the initial reaction was performed at 70° C. for 24 hours, as described in Comparative Example 1. In the treatment group, the initial reaction was performed at 70° C. for 4 hours, followed by at 60° C. for 20 hours. This reaction was repeated daily for 7 days and the enzyme used for the interesterification was collected from the reaction samples daily. After completing the reaction, fats were removed from the enzyme by chloroform. The remaining solvent was removed from the enzyme at room temperature and at a dryer at 40° C. under a reduced pressure, and the residual activity of enzyme was measured, while keeping the enzyme in a refrigerator at 4° C. The result is shown in Table 2.

TABLE 2
Residual activity of enzyme (Degree of conversion: DC %)

| Time (days) | Control | Treatment |
|---|---|---|
| 0 | 47 | 47 |
| 1 | 31 | 47 |
| 2 | 29 | 42 |
| 3 | 23 | 37 |
| 4 | 21 | 33 |
| 5 | 20 | 31 |
| 6 | 17 | 27 |
| 7 | 16 | 27 |

Control group: enzyme treated daily at 70° C. for 24 hours

Treatment group: enzyme treated daily at 70° C. for 4 hours and 60° C. for 20 hours

The residual activity of enzyme was measured according to a method described in Food Chemicals Codex and the result calculated according to Equation 2. The result is shown in Table 3. As a result, the treatment group showed a residual activity of enzyme about 1.5 to 1.7 times higher than that in the control group.

TABLE 3
Residual activity of enzyme (hydrolysis titer)

| Time (days) | Control (Lu/g) | Treatment (Lu/g) |
|---|---|---|
| 0 | 209579 | 209579 |
| 1 | 139886 | 211835 |
| 2 | 132360 | 188864 |
| 3 | 103972 | 167704 |
| 4 | 95755 | 147674 |
| 5 | 89814 | 138621 |
| 6 | 75584 | 122993 |
| 7 | 70502 | 122442 |

Control group: enzyme treated daily at 70° C. for 24 hours

Treatment group: enzyme treated daily at 70° C. for 4 hours and 60° C. for 20 hours

Lu/g=(R×N×1000)/W Equation 2

R: amount in ml of the titrated material per min at a linear range

N: normal concentration of sodium hydroxide

1000: coefficient to convert mmol unit to μmol unit in an acid

W: amount of enzyme contained in 1 ml of sample solution (final dilution)

As shown above, there was no significant difference between Comparative Example 1 and Example 3 in the aspects of the degree of conversion and the physical property, whereas Example 3 exhibited a superior residual activity of enzyme, compared with Comparative Example 1. According to the present invention, an optimum condition for an enzymatic interesterification process using stepwise changes in temperature has been found, and the fat and oil having the same degree of conversion and the same physical property as those given by an enzymatic interesterification process at a high temperature were produced. Further, as evidenced by the measurement of the residual activity of enzyme, since the residual activity of enzyme was high, the method of the present invention that is conducted using stepwise changes in temperature is beneficial for economy.

While the present invention has been described with reference to the particular illustrative embodiments, it is not to be restricted by the embodiments but only by the appended claims. It should be appreciated that those skilled in the art can change or modify the embodiments without departing from the scope and spirit of the present invention.

1. A method of preparing fats and oils by an enzymatic interesterification, comprising the steps of:
1) mixing fully hydrogenated fat derived from canola oil with olive oil;
2) adding lipase to the mixed oil and reacting the mixed oil with lipase at 65 to 80° C. for 1 to 4 hours (1st reaction step); and
3) reacting the mixed oil from step 2) with the lipase at 40 to 60° C. for 44 to 47 hours (2nd reaction step).

2. The method according to claim 1, wherein the oils in step 1) are mixed in a ratio of 1:9 to 9:1 by weight expressed as the fully hydrogenated fat derived from canola oil to the olive oil.

3. The method according to claim 1, wherein the lipase is one or more selected from the group consisting of lipases derived from microorganisms comprising Rhizopus delemar, Mucor miehei, Alicaligenes sp. Aspergillus niger, Candida antarctica, Candida cylindracea, and Geotrichum candidum; lipases derived from plants comprising soybean Minuka hima seed; and pancreatic lipases derived from animals.

4. The method according to claim 1, wherein the lipase is added to the mixed oil in an amount of 1% by weight.

5. An oil and fat prepared by the method according to claim 1.

6. An oil and fat prepared by the method according to claim 2.

7. An oil and fat prepared by the method according to claim 3.

8. An oil and fat prepared by the method according to claim 4.
